(19) United States
(12) Patent Application Publication
(10) Pub. No.: US 2022/0171742 A1
(43) Pub. Date: Jun. 2, 2022

(54) ELECTRONIC DEVICE AND METHOD FOR CONTROLLING ELECTRONIC DEVICE

(71) Applicant: UNIST (ULSAN NATIONAL INSTITUTE OF SCIENCE AND TECHNOLOGY), Ulsan (KR)

(72) Inventors: Sam Hyuk NOH, ULSAN (KR); Hyeonho SONG, ULSAN (KR)

(21) Appl. No.: 17/170,781

(22) Filed: Feb. 8, 2021

(30) Foreign Application Priority Data
Dec. 2, 2020 (KR) 10-2020-0166864

(51) Int. Cl. G06F 16/18; G06F 16/14; G06F 12/06

(52) U.S. Cl. CPC G06F 16/18; G06F 2212/163; G06F 12/0646; G06F 16/14

(57) ABSTRACT

An electronic device and a method for controlling the same are disclosed. The electronic device of the disclosure includes a first memory including a main memory area and a file system area to which a pseudo file mapped with the main memory area is allocated, a second memory configured to operate as a main memory, and a processor configured to adjust percentages of the main memory area and the file system area on the first memory by allocating a free block included in the file system area to the pseudo file based on a size of an free page of the second memory.

### CROSS-REFERENCE TO RELATED APPLICATION

This application is based on and claims priority under 35 U.S.C. §119 to Korean Patent Application No. 10-2020-0166864, filed on Dec. 2, 2020, in the Korean Intellectual Property Office, the disclosure of which is incorporated by reference herein in its entirety.

### BACKGROUND

### 1. Field

The disclosure relates to an electronic device and a method for controlling an electronic device, and more particularly to an electronic device for adjusting percentages of a main memory area and a file system area on a memory and a method for controlling the same.

### 2. Description of Related Art

In the related art, a persistent memory (PM) was divided in a unit of namespaces and an operation mode is designated and managed in the divided namespace. The operation mode designated in the namespace may include a devdax mode capable of operating the namespace as a main memory and a fsdax mode for operating the namespace as a storage.

As illustrated in FIG. 1, a persistent memory 1 may be divided into a fsdax namespace 3 operated in the fxdax mode and a devdax namespace 4 operated in the devdax mode.

Meanwhile, in the related art, there was a limit that it is necessary to initiate and reset the namespace, in order to change a size or the designated operation mode of the namespace. For example, in order to increase the percentage of the fsdax namespace 3 and reduce the percentage of the devdax namespace 4, it is necessary to end all application programs being executed in the persistent memory 1 or return resources. In addition, the devdax namespace 4 operated as the main memory is hot-off and a file system 5 mounted on the fsdax namespace 3 area should be unmounted. Then, it is necessary to generate namespaces having new proportions after destroying the namespaces 3 and 4.

In other words, in the case of the technology of the related art, in order to adjust the percentage of each namespace, there is limitation that it is necessary that all of data included in the file system mounted on the fsdax namespace 3 is lost and the execution of the application program being executed in the devdax namespace 4 is stopped.

### SUMMARY

The disclosure is made to solve the problem described above and an object of the disclosure is to provide an electronic device for dynamically controlling percentages of a main memory area and a storage area on a memory and a method for controlling the same.

According to an embodiment of the disclosure, there is provided an electronic device including a first memory including a main memory area and a file system area to which a pseudo file mapped with the main memory area is allocated, a second memory configured to operate as a main memory, and a processor configured to adjust percentages of the main memory area and the file system area on the first memory by allocating an free block included in the file system area to the pseudo file based on a size of a free page of the second memory.

The processor may be configured to, based on the size of the free page of the second memory being less than a first threshold value, allocate the free block included in the file system area to the pseudo file.

The processor may be configured to, based on the size of the free page of the second memory being a second threshold value or more, allocate the free page included in the main memory area to the file system area.

The processor may be configured to allocate a first block among free blocks included in the file system area to the pseudo file, and increase the percentage of the main memory area on the first memory by mapping the first block allocated to the pseudo file with the main memory area.

The processor may be configured to identify a physical frame number of the first block, obtain a struct page corresponding to the first block by using the identified physical frame number, and map the first block with the main memory area by connecting the obtained struct page to a buddy system structure included in the main memory area.

The processor may be configured to control a first page of free pages included in the main memory area to be allocated to the file system area so that other application programs are not allocated to the first page.

The processor may be configured to identify a physical frame number corresponding to the first page, search for a second block corresponding to the identified physical frame number among blocks included in the pseudo file, and increase the percentage of the file system area on the first memory by deallocating the searched second block to the file system area.

The processor may be configured to, based on a size of the free block included in the file system area being lower than a third threshold value, allocate the free page included in the main memory area to the file system area.

According to another aspect of the disclosure, there is provided a method for controlling an electronic device including a first memory including a main memory area and a file system area to which a pseudo file mapped with the main memory area is allocated, and a second memory configured to operate as a main memory, the method including monitoring a size of a free page included in the second memory, and adjusting percentages of the main memory area and the file system area on the first memory by allocating a free block included in the file system area to the pseudo file based on the size of the free page included the second memory.

The adjusting may include, based on the size of the free page of the second memory being less than a first threshold value, allocating the free block included in the file system area to the pseudo file.

The adjusting may include, based on the size of the free page of the second memory being a second threshold value or more, allocating the free page included in the main memory area to the file system area.

The adjusting may include allocating a first block among free blocks included in the file system area to the pseudo file, and increasing the percentage of the main memory area on the first memory by mapping the first block allocated to the pseudo file with the main memory area.

The mapping the first block allocated to the pseudo file with the main memory area may include identifying a physical frame number of the first block, obtaining a struct page corresponding to the first block by using the identified physical frame number, and mapping the first block with the main memory area by connecting the obtained struct page to a buddy system structure included in the main memory area.

The allocating the free page included in the main memory area to the file system area may include controlling a first page of free pages included in the main memory area to be allocated to the file system area so that other application programs are not allocated to the first page.

The allocating the free page included in the main memory area to the file system area may include identifying a physical frame number corresponding to the first page, searching for a second block corresponding to the identified physical frame number among blocks included in the pseudo file, and increasing the percentage of the file system area on the first memory by deallocating the searched second block to the file system area.

The control method may further include monitoring a size of a free block included in the file system area, and, based on a size of the free block included in the file system area being lower than a third threshold value, allocating the free page included in the main memory area to the file system area.

According to the various embodiments of the disclosure, the electronic device may reduce consumed overhead and improve memory utilization by efficiently adjusting the percentages of the main memory area and the storage area on the memory.

### BRIEF DESCRIPTION OF THE DRAWINGS

The above and other aspects, features, and advantages of certain embodiments of the present disclosure will be more apparent from the following detailed description taken in conjunction with the accompanying drawings, in which:

FIG. 1 is a diagram illustrating a namespace management method on a PM of the related art;

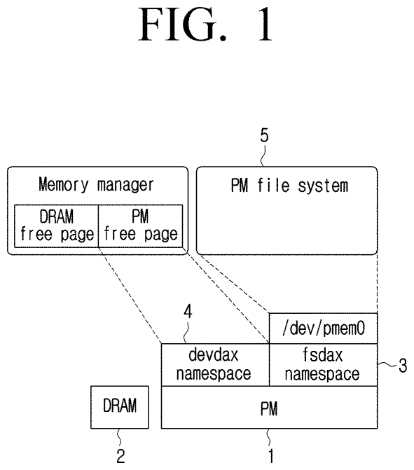

FIG. 2 is a block diagram schematically illustrating a configuration of an electronic device according to an embodiment;

FIG. 3 is a diagram illustrating a process in which an electronic device adjusts percentages of a main memory area and a file system area according to an embodiment;

FIG. 4A is a diagram illustrating a process in which an electronic device maps a free block included in a file system with a main memory area according to an embodiment;

FIG. 4B is a diagram illustrating a process in which an electronic device allocates a free page included in a main memory area to a file system according to an embodiment;

FIG. 5 is a diagram illustrating an operation of a software module on an electronic device according to an embodiment;

FIG. 6 is a diagram illustrating an operation and an architecture of an electronic device according to an embodiment; and

FIG. 7 is a flowchart illustrating a method for controlling an electronic device according to an embodiment.

### DETAILED DESCRIPTION

The disclosure will be described in greater detail below after briefly explaining the terms used in the disclosure.

The terms used in embodiments of the disclosure have been selected as widely used general terms as possible in consideration of functions in the disclosure, but these may vary in accordance with the intention of those skilled in the art, the precedent, the emergence of new technologies and the like. In addition, in a certain case, there may also be an arbitrarily selected term, in which case the meaning will be described in the description of the disclosure. Therefore, the terms used in the disclosure should be defined based on the meanings of the terms themselves and the contents throughout the disclosure, rather than the simple names of the terms.

The embodiments of the disclosure may be variously changed and include various embodiments, and specific embodiments will be shown in the drawings and described in detail in the description. However, it should be understood that this is not to limit the scope of the specific embodiments and all modifications, equivalents, and/or alternatives included in the disclosed spirit and technical scope are included. In describing the disclosure, a detailed description of the related art may be omitted when it is determined that the detailed description may unnecessarily obscure a gist of the disclosure.

In describing the disclosure, it should be understood that the order of each step is not limited, unless a previous step should be performed before a subsequent step logically and in time. In other words, other than the above exceptions, the gist of the disclosure is not affected even if the process described as the subsequent step is performed before the process described as the previous step, and a scope of a right also should be defined regardless of the order of steps.

The terms “first,” “second,” or the like may be used for describing various elements but the elements may not be limited by the terms. The terms are used only to distinguish one element from another.

Unless otherwise defined specifically, a singular expression may encompass a plural expression. It is to be understood that the terms such as “comprise” or “consist of” are used herein to designate a presence of characteristic, number, step, operation, element, part, or a combination thereof, and not to preclude a presence or a possibility of adding one or more of other characteristics, numbers, steps, operations, elements, parts or a combination thereof.

Meanwhile, a “module” or a “unit” in the disclosure may perform at least one function or operation. In addition, the “module” or the “unit” may perform the function or the operation by hardware, software, or a combination of hardware and software. In addition, a plurality of “modules” and a plurality of “units”, except for a “module” or a “unit” which should be performed in a specific hardware or performed in at least one processor, may be integrated into one module. Unless otherwise defined specifically, a singular expression may encompass a plural expression.

Hereinafter, various embodiments of the disclosure will be described with reference to the drawings.

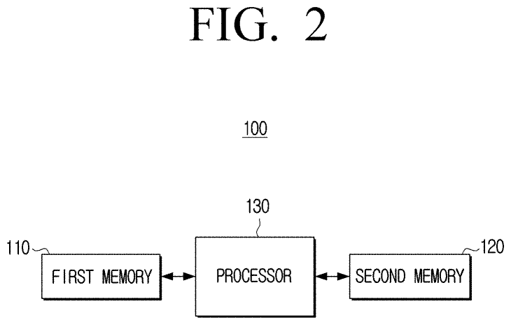

FIG. 2 is a block diagram schematically illustrating a configuration of an electronic device 100 according to an embodiment. Referring to FIG. 2, the electronic device 100 may include a first memory 110, a second memory 120, and a processor 130. Herein, the electronic device 100 may be implemented as various devices such as various terminal devices (e.g., a tablet PC, a smartphone, or the like), a desktop PC, a notebook PC, a server, a server device providing a cloud service, a wearable device, a medical device, and the like.

However, the configuration illustrated in FIG. 2 is merely an exemplary diagram for implementing an embodiment of the disclosure, and suitable hardware and software configuration apparent to those skilled in the art may be additionally included in the electronic device 100.

The first memory 110 may be implemented as a persistent memory (PM). The first memory 110 may include a main memory area and a file system area to which a pseudo file mapped with the main memory area is allocated. The main memory area may play a role of a main memory of the related art used in an operation process, and the file system area may play a role of a storage of the related art storing various final data such as an operation result.

The pseudo file may refer to file allocated to the file system and maintaining an area capable of being mapped with the main memory area. The pseudo file may be managed by the same method as a general file. For example, a size of the pseudo file may be enlarged or reduced to store data. The pseudo file is a NULL path file thus is not visible to a user.

The pseudo file is allocated to the file system but the area allocated to the pseudo file may be used as the main memory. For example, when a free block included in the file system is allocated to the pseudo file, the block allocated to the pseudo file may be mapped with the main memory area, and accordingly, a percentage of the main memory area in the first memory 110 may be increased. The size of the pseudo file may be a maximum size of a block capable of being with the main memory area, that is, a block capable of being exported to the main memory area. The block herein may refer to a unit divided from a storage space on the file system based on a preset standard or arbitrarily.

The second memory 120 may be an element operating as the main memory. The second memory 120 may be implemented as a dynamic random-access memory (DRAM) but this is merely an embodiment, and the second memory may be implemented as other types of RAM.

A free page of the second memory 120 and a free page of the main memory area of the first memory 110 may be managed by a memory manager and allocated to a user space.

The processor 130 may control general operations and functions of the electronic device 100. The processor 130 may be configured with one or a plurality of processors. The one or the plurality of processors may be a general-purpose processor such as a CPU, an AP, or a digital signal processor (DSP), a graphics dedicated processor such as a GPU or a vision processing unit (VPU), or an artificial intelligence dedicated processor such as an NPU, or the like.

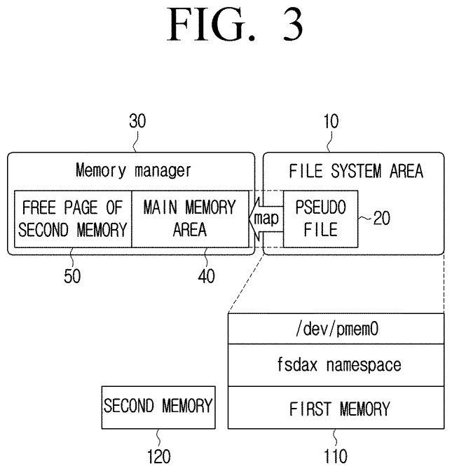

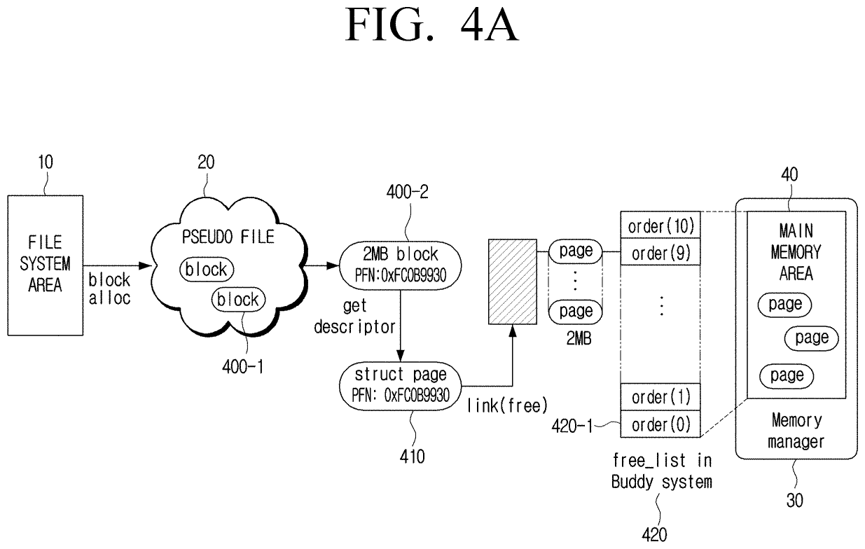

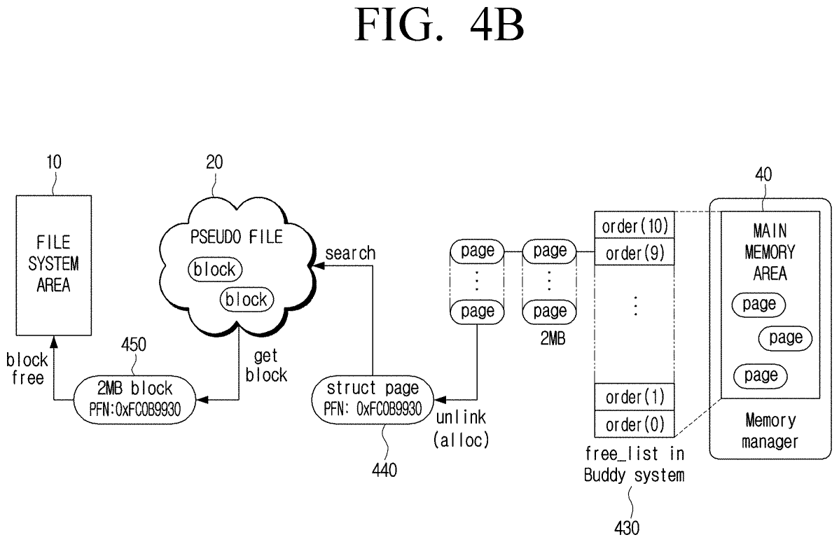

The processor 130 may dynamically adjust percentages of the main memory area and the file system area on the first memory 110 by allocating a free block included in the file system area to the pseudo file or allocating a free page included in the main memory area to the file system. The process of adjusting the percentages of the main memory area and the file system area will be described in detail with reference to FIGS. 3, 4A and 4B.

Referring to FIG. 3, when the processor 130 allocates the free block included in a file system area 10 to a pseudo file 20, a percentage of a main memory area 40 in the first memory 110 may increase. When the processor 130 allocates the free page included in the main memory area 40 to the file system area 10, a percentage of the file system area 10 in the first memory 110 may increase.

In an embodiment of the disclosure, the processor 130 may adjust the percentages of the main memory area 40 and the file system area 10 on the first memory 110 by allocating the free block included in the file system area 10 to the pseudo file 20 based on a size of a free page 50 of the second memory 120. In other words, the processor 130 may adjust the percentages of the main memory area 40 and the file system area 10 on the first memory 110 by monitoring the size of the free page 50 of the second memory 120 and allocating the free block included in the file system area 10 to the pseudo file 20 according to the monitoring result.

In an embodiment, if the size of the free page of the second memory 120 is less than a first threshold value, the processor 130 may allocate the free block included in the file system area 10 to the pseudo file 20. The first threshold value herein may be a preset value (e.g., 5 gigabytes (GB)) derived by experiments or research, but is not limited thereto and may be freely changed by a user.

Specifically, the processor 120 may allocate a first block of the free block included in the file system area 10 to the pseudo file 20. The area allocated to the pseudo file 20 is mapped with the main memory area and used as the main memory, and accordingly, when the first block of the free block is allocated to the pseudo file 20, the first block is not used for the purpose of the storage.

In addition, the processor 120 may increase the percentage of the main memory area 40 on the first memory 110 by mapping the first block allocated to the pseudo file to the main memory area 40. The mapping of the first block to the main memory area 40 may imply that the first block is processed to be treated as a free page of the main memory area 40 capable of being allocated to a user space.

Specifically, referring to FIG. 4A, the processor 120 may allocate a first block 400-1 in the file system area 10. The processor 120 may identify a physical frame number (PFN) 400-2 of the first block 400-1. The processor 120 may identify the physical frame number 400-2 of the first block by using a block number included in the file system area 10. The processor 120 may obtain a struct page 410 of the first block by using the identified physical frame number 400-2 of the first block.

The struct page may refer to an object for displaying a state of each physical memory area having each preset size (e.g., 4 KB). In other words, in each physical memory area having a preset size, the corresponding struct page exists. The struct page may include a physical address, a number of application programs using the corresponding physical memory area, a pointer to be configured as various material structures, and the like. For example, the area being used in the file system area 10 of the first memory 110 is also one of the physical memory area, and accordingly, the struct page exists for each of the area having a preset size (e.g., 4 KB).

The processor 130 may map the first block with the main memory area by connecting the obtained struct page to a buddy system structure 420 included in the main memory area 40. The main memory area 40 may include at least one struct page connected to the buddy system structure 420. The processor 130 may connect the struct page of the first block to order(0) free_list connected to a lowest order of the buddy system structure 420. The struct page of the first block connected to the buddy system structure 420 may be allocated to the user space as the free page included in the main memory area 40.

Referring to FIG. 3, in another embodiment of the disclosure, when the size of the free page of the second memory 120 is a second threshold value or more, the processor 130 may allocate the free page included in the main memory area 40 to the file system area 10. The free page included in the main memory area 40 herein may be a struct page included in the buddy system structure. In addition, the allocation of the free page included in the main memory area 40 to the file system area 10 may imply that the free block usable for the storage on the file system area 10 increases. The second threshold value may be a preset value (e.g., 32 gigabytes) derived by experiments or research, but is not limited thereto and may be freely changed by a user.

The processor 130 may control a first page of the free page included in the main memory area 40 to be allocated to the file system area 40 so that other application programs are not allocated to the first page. Specifically, referring to FIG. 4B, the processor 130 may identify a physical frame number 440 corresponding to the first page of the free page included in the buddy system structure 430 (e.g., struct page included in the buddy system structure 430).

The processor 130 may search for a second block corresponding to the identified physical frame number 440 corresponding to the first page among the blocks included in the pseudo file 20. The processor 130 may deallocate the searched second block 450 to the file system and increase the percentage of the file system area 10 on the first memory 110. The deallocating of the second block 450 to the file system area 10 may imply that the second block is allocated to the area in the file system area 10 for storing the free block.

In still another embodiment of the disclosure, the processor 130 may allocate the free page included in the main memory area 40 to the file system area 10 based on the size of the free block included in the file system area 10. In other words, the processor 130 may monitor the size of the free block included in the file system area 10 and allocate the free page included in the main memory area 40 to the file system area 10 based on the monitoring result.

In an embodiment, if the size of the free block included in the file system area 10 is less than a third threshold value, the processor 130 may allocate the free page included in the main memory area 40 to the file system area 10. In other words, if the free block used for the storage on the file system area 10 is insufficient, the processor 130 may allocate the free page included in the main memory area 40 to the file system area 10 and increase the percentage of the file system area 10. The process in which the processor 130 allocates the free page included in the main memory area 40 to the file system area 10 has been described above, and therefore the overlapped description will not be repeated.

In still another embodiment, if the size of the free block included in the file system area 10 is the third threshold value or more, the processor 130 may allocate the free block included in the file system area 10 to the pseudo file 20. In other words, if the free block used for the storage on the file system area 10 is sufficient, the processor 130 may allocate the free block included in the file system area 10 to the pseudo file 20 and increase the percentage of the main memory area 40. The process in which the processor 130 allocates the free block included in the file system area 10 to the pseudo file 20 has been described above, and therefore the overlapped description will not be repeated. Meanwhile, the third threshold value may be a preset value derived by experiments or research, but is not limited thereto and may be freely changed by a user.

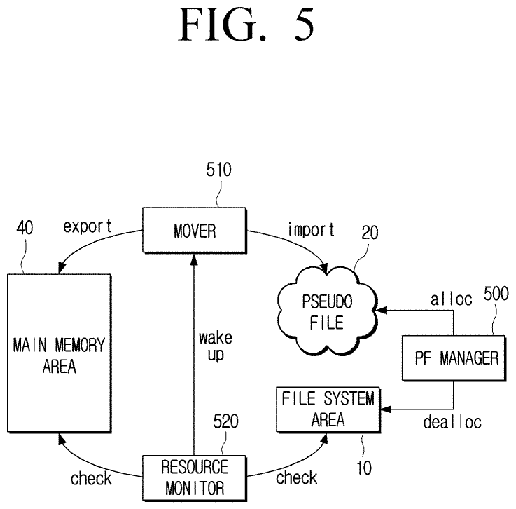

FIG. 5 is a diagram illustrating an operation of a module included on the electronic device 100 according to an embodiment. Each module illustrated in FIG. 5 may be controlled by the processor 130.

A pseudo file (PF) manager module 500 may perform operations of generating and managing the pseudo file 20 (e.g., change of size of the pseudo file 20) on the file system area 10. The PF manager module 500 may allocate the free block included on the file system area 10 to the pseudo file 20 or deallocate the block included in the pseudo file 20 to the file system area 10.

A mover module 520 may perform an operation of mapping the block included in the pseudo file 20 with the main memory area 40 and an operation of allocating the page included in the main memory area 40 to the pseudo file 20. The operation performed by the mover module 520 is a logical operation and thus, the block does not actually move.

A resource monitor module 520 may perform an operation of monitoring a resource related to a system for adjusting the percentages of the main memory area and the file system area on the first memory. For example, the resource monitoring module 520 may monitor whether the size of the free page of the second memory is reduced to less than the first threshold value. In another embodiment, the resource monitoring module 520 may monitor whether the size of the free block included in the file system area is reduced to less than the third threshold value.

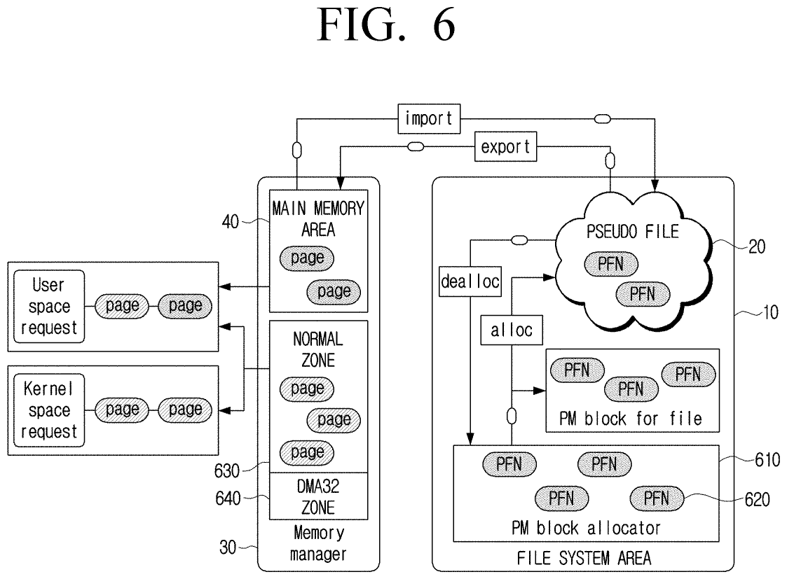

FIG. 6 is a diagram illustrating an operation and an architecture of the electronic device 100 according to an embodiment.

In an embodiment, the process in which the electronic device 100 maps the free block included in the file system area 10 with the main memory area 40 will be described with reference to FIG. 6.

The electronic device 100 may control a first block 620 of a plurality of free blocks included in a PM block allocator 610 to be allocated to the pseudo file 20 so that the first block 620 is not used for the storage. In other words, since the first block 620 is allocated to a specific file, the first block 620 may be treated as a block being used from a viewpoint of the file system area 610.

The electronic device 100 may increase the percentage of the main memory 40 in the first memory by mapping the first block 620 allocated to the pseudo file 20 with the main memory area 40. By mapping the first block 620 on the main memory area 40, the free page added to the main memory area 40 may be allocated to a user space 650 according to a user request.

Meanwhile, as illustrated in FIG. 6, a memory manager 30 may include various types of zones (e.g., NORMAL ZONE 630, DMA32 ZONE 640, and the like). The zone may refer to an assembly unit of pages of similar attributes. The NORMAL ZONE 630 and the DMA32 ZONE 640 may include the free page of the second memory.

In another embodiment of the disclosure, the process in which the electronic device 100 allocates the free page included in the main memory area 40 to the file system area 10 will be described with reference to FIG. 6.

The electronic device 100 may allocate the first page of the free page included in the main memory area 40 to the pseudo file 20. The first page may be a struct page connected to the buddy system structure on the main memory area 40. Specifically, the electronic device 100 may identify physical frame number corresponding to the first page and search for the second block corresponding to the identified physical frame number of the blocks included in the pseudo file 20. The electronic device 100 may deallocate the second block included in the pseudo file 20 to the PM block allocator 610 and increase the percentage of the file system area in the first memory.

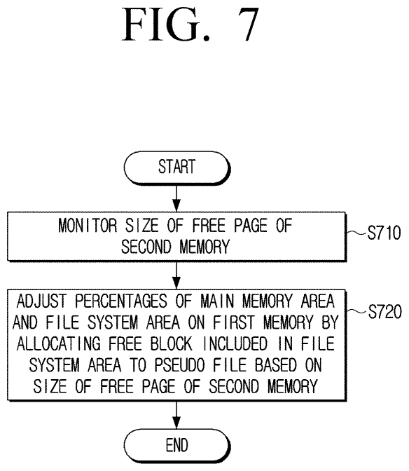

FIG. 7 is a flowchart illustrating a method for controlling the electronic device 100 according to an embodiment.

The electronic device 100 may monitor the size of the free page of the second memory (S710). The small size of the free page of the second memory may imply that it is difficult for the electronic device 100 to perform various operations or execute an application program by using the second memory.

The electronic device 100 may adjust the percentages of the main memory area and the file system area on the first memory by allocating the free block included in the file system area to the pseudo file based on the size of the free page of the second memory (S720).

For example, if the size of the free page of the second memory is less than the first threshold value, the electronic device 100 may allocate the free block included in the file system area to the pseudo file. Accordingly, the percentage of the file system area on the first memory may increase.

In another example, if the size of the free page of the second memory is second threshold value or more, the electronic device 100 may allocate the free page included in the main memory area to the file system area. Accordingly, the percentage of the main memory area on the first memory may increase.

Through various embodiments of the disclosure, the electronic device 100 may dynamically change the use of the first memory without resetting the namespace on the first memory.

The control method described above may be implemented as a program including an algorithm to be executed on a computer and the program may be stored and provided in a non-transitory computer readable medium.

The non-transitory computer-readable medium is not a medium storing data for a short period of time such as a register, a cache, or a memory, but may refer to a medium that semi-permanently stores data and is readable by a machine. Specifically, the various applications or programs described above may be stored and provided to the non-transitory computer-readable medium such as a CD, a DVD, a hard disk drive, a Blu-ray disc, a USB, a memory card, and a ROM.

While preferred embodiments of the disclosure have been shown and described, the disclosure is not limited to the aforementioned specific embodiments, and it is apparent that various modifications can be made by those having ordinary skill in the technical field to which the disclosure belongs, without departing from the gist of the disclosure as claimed by the appended claims. Also, it is intended that such modifications are not to be interpreted independently from the technical idea or prospect of the disclosure.

What is claimed is:

1. An electronic device comprising:
a first memory comprising a main memory area and a file system area to which a pseudo file mapped with the main memory area is allocated;
a second memory configured to operate as a main memory; and
a processor configured to adjust percentages of the main memory area and the file system area on the first memory by allocating a free block included in the file system area to the pseudo file based on a size of a free page of the second memory.

2. The electronic device according to claim 1, wherein the processor is configured to, based on the size of the free page of the second memory being less than a first threshold value, allocate the free block included in the file system area to the pseudo file.

3. The electronic device according to claim 1, wherein the processor is configured to, based on the size of the free page of the second memory being a second threshold value or more, allocate the free page included in the main memory area to the file system area.

4. The electronic device according to claim 1, wherein the processor is configured to:
allocate a first block among free blocks included in the file system area to the pseudo file; and
increase the percentage of the main memory area on the first memory by mapping the first block allocated to the pseudo file with the main memory area.

5. The electronic device according to claim 4, wherein the processor is configured to:
identify a physical frame number of the first block;
obtain a struct page corresponding to the first block by using the identified physical frame number; and
map the first block with the main memory area by connecting the obtained struct page to a buddy system structure included in the main memory area.

6. The electronic device according to claim 3, wherein the processor is configured to control a first page of free pages included in the main memory area to be allocated to the file system area so that other application programs are not allocated to the first page.

7. The electronic device according to claim 6, wherein the processor is configured to:
identify a physical frame number corresponding to the first page;
search for a second block corresponding to the identified physical frame number among blocks included in the pseudo file; and
increase the percentage of the file system area on the first memory by deallocating the searched second block to the file system area.

8. The electronic device according to claim 1, wherein the processor is configured to, based on a size of the free block included in the file system area being lower than a third threshold value, allocate the free page included in the main memory area to the file system area.

9. A method for controlling an electronic device comprising a first memory comprising a main memory area and a file system area to which a pseudo file mapped with the main memory area is allocated, and a second memory configured to operate as a main memory, the method comprising:
monitoring a size of an free page included in the second memory; and
adjusting percentages of the main memory area and the file system area on the first memory by allocating a free block included in the file system area to the pseudo file based on the size of the free page included the second memory.

10. The method according to claim 9, wherein the adjusting comprises, based on the size of the free page of the second memory being less than a first threshold value, allocating the free block included in the file system area to the pseudo file.

11. The method according to claim 9, wherein the adjusting comprises, based on the size of the free page of the second memory being a second threshold value or more, allocating the free page included in the main memory area to the file system area.

12. The method according to claim 9, wherein the adjusting comprises:
allocating a first block among free blocks included in the file system area to the pseudo file; and
increasing the percentage of the main memory area on the first memory by mapping the first block allocated to the pseudo file with the main memory area.

13. The method according to claim 12, wherein the mapping the first block allocated to the pseudo file with the main memory area comprises:
identifying a physical frame number of the first block;
obtaining a struct page corresponding to the first block by using the identified physical frame number; and
mapping the first block with the main memory area by connecting the obtained struct page to a buddy system structure included in the main memory area.

14. The method according to claim 11, wherein the allocating the free page included in the main memory area to the file system area comprises controlling a first page of free pages included in the main memory area to be allocated to the file system area so that other application programs are not allocated to the first page.

15. The method according to claim 14, wherein the allocating the free page included in the main memory area to the file system area comprises:
identifying a physical frame number corresponding to the first page;
searching for a second block corresponding to the identified physical frame number among blocks included in the pseudo file; and
increasing the percentage of the file system area on the first memory by deallocating the searched second block to the file system area.

16. The method according to claim 9, further comprising:
monitoring a size of a free block included in the file system area; and
based on a size of the free block included in the file system area being lower than a third threshold value, allocating the free page included in the main memory area to the file system area.
